(19) United States
(12) Patent Application Publication
(10) Pub. No.: US 2009/0009884 A1
(43) Pub. Date: Jan. 8, 2009

(54) Zoom Lens and image pickup apparatus

(75) Inventors: Motoyuki Ohtake, Saitama (JP); Atsushi Suzuki, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/007,853

(22) Filed: Jan. 16, 2008

(30) Foreign Application Priority Data
Feb. 19, 2007 (JP) 2007-038303

(51) Int. Cl. G02B 15/14

(52) U.S. Cl. 359/689

(57) ABSTRACT

A zoom lens includes first to third lens groups having negative, positive, and positive refractive powers, respectively. When a lens position state changes from a wide-angle to a telephoto, all lens groups are moved in an optical axis direction so that a distance between the first and second lens groups decreases and a distance between the second and third lens groups increases. A close-distance focusing is accomplished by moving the third lens group. The first lens group is composed of negative and positive lens components. The second lens group is composed of a positive lens component, and a cemented lens composed of a positive lens of biconvex shape, and a negative lens of biconcave shape. The third lens group is composed of a positive lens component in which at least one of object-side and image-side lens surfaces is aspheric. The zoom lens is satisfied a predetermined condition.

### BACKGROUND OF THE INVENTION

1. Field of the Invention

The present invention relates to a new zoom lens and a new image pickup apparatus. In particular, the present invention relates to a small zoom lens and an image pickup apparatus using the zoom lens.

2. Description of Related Art

To record a subject image on cameras, a method for recording the subject image on an image pickup apparatus in which a photoelectric conversion element such as CCD (charge coupled device) or CMOS (complementary metal oxide semiconductor) is used has been known. In the method, the subject image formed on the image pickup apparatus is recorded by converting the intensity of the subject image to an electrical output using the respective photoelectric conversion elements.

For example, a negative-positive-positive 3-group zoom lens is known as a suitable zoom lens for so-called digital video cameras and digital still cameras, which record a subject image by image pickup elements using these photoelectric conversion elements.

The negative-positive-positive 3-group zoom lens is configured by arranging, in order from an object side, three lens groups of a first lens group having a negative refractive power, a second lens group having a positive refractive power and a third lens group having a positive refractive power. When the lens position state changes from the maximum wide angle state having the shortest focal length to the maximum telephoto state having the longest focal length, at least the second lens group is moved to the object side, and the first and third lens groups are moved in the optical axis direction so that a distance between the first lens group and the second lens group decreases, and a distance between the second lens group and the third lens group increases.

Specifically, those described in, for example, Japanese Unexamined Patent Application Publication Nos. 2000-89110, 2002-277740, 2001-318311 and 2003-307677 are known.

### SUMMARY OF THE INVENTION

However, there is an issue in the known negative-positive-positive 3-group zoom lens. That is, the entire lens length in the maximum wide angle state is large, making it difficult to reduce a height of the camera body. Further, the tilting of a cam track for moving the first lens group is too steep to ensure sufficient stop accuracy.

In view of the foregoing issue, it is desirable to provide a zoom lens suitable for miniaturizing the camera body, and an image pickup apparatus using the zoom lens.

According to an embodiment of the present invention, there is provided a zoom lens including a first lens group having a negative refractive power, a second lens group having a positive refractive power and a third lens group having a positive refractive power, the first, second, and third lens groups being arranged in this order from an object side. When a lens position state changes from a maximum wide angle state to a maximum telephoto state, all of the lens groups are moved in an optical axis direction and at least the second lens group is moved to the object side, and the third lens group is moved to an image side so that a distance between the first lens group and the second lens group decreases and a distance between the second lens group and the third lens group increases. When a subject position changes, the third lens group is moved to perform close-distance focusing. The first lens group is composed of a negative lens component whose concave surface is directed to the image side and image side lens surface is aspheric, and a positive lens component of meniscus shape whose concave surface is directed to the image side, the positive lens component being arranged on the image side of the negative lens component with air space therebetween. The second lens group is composed of a positive lens component, and a cemented lens composed of a positive lens of biconvex shape and a negative lens of biconcave shape, the cemented lens being arranged on the image side of the positive lens component with air space therebetween. The third lens group is composed of a positive lens component where at least one of an object-side lens surface and an image-side lens surface is aspheric. The zoom lens satisfies the following conditional expression (1): 0.12<φ24·fw<0.22, where φ24 is a refractive power of a cemented surface of the cemented lens arranged in the second lens group, and defined by the following equation: φ24=(n5−n4)/R24 (n5<n4), where n5 is a refractive index with respect to a d-line (having a wavelength of 587.6 nm) of the negative lens composing the cemented lens arranged in the second lens group; n4 is a refractive index with respect to a d-line of the positive lens composing the cemented lens arranged in the second lens group; R24 is a curvature radius of the cemented surface of the cemented lens arranged in the second lens group; and fw is a focal length of the entire lens system in the maximum wide angle state.

An image pickup apparatus according to an embodiment of the present invention includes the zoom lens according to the abovementioned embodiment of the present invention, and a solid image pickup element for converting an optical image formed by the zoom lens into an electrical signal.

According to embodiments of the present invention, the camera body may be miniaturized.

### BRIEF DESCRIPTION OF THE DRAWINGS

FIG. 1 shows a diagram showing the refractive power arrangement in an embodiment of a zoom lens of the invention;

FIG. 2 shows a diagram showing the lens configuration of a first embodiment of the zoom lens of the invention;

FIGS. 3 to 5 are aberration graphs of a numerical example 1, in which specific numerical values are applied to the first embodiment, particularly, FIG. 3 showing spherical aberration, astigmatic aberration, distortion aberration and transverse aberration in the maximum wide angle state, FIGS. 4A and 4B showing those in the middle focal length state, and FIG. 5 showing those in the maximum telephoto state;

FIG. 6 shows a diagram showing the lens configuration of a second embodiment of the zoom lens of the invention;

FIGS. 7 to 9 are aberration graphs of a numerical example 2, in which specific numerical examples are applied to the second embodiment, particularly, FIG. 7 showing spherical aberration, astigmatic aberration, distortion aberration and transverse aberration in the maximum wide angle state, FIG. 8 showing those in the middle focal length state, and FIG. 9 showing those in the maximum telephoto state;

FIG. 10 shows a diagram showing the lens configuration of a third embodiment of the zoom lens of the invention;

FIGS. 11 to 13 are aberration graphs of a numerical example 3, in which specific numerical values are applied to the third embodiment, particularly, FIG. 11 showing spherical aberration, astigmatic aberration, distortion aberration and transverse aberration in the maximum wide angle state, FIG. 12 showing those in the middle focal length state, and FIG. 13 showing those in the maximum telephoto state;

FIGS. 14A and 14B are schematic sectional views showing the lens barrel structure in a non collapsible type camera;

FIG. 15 shows a diagram showing the shape of a cam groove formed in the internal surface of the lens barrel of a conventional collapsible type camera;

FIG. 16 shows a diagram showing in enlarged dimension a part of the cam groove shown in FIG. 15;

FIG. 17 shows a diagram showing the shape of a cam groove formed in the internal surface of a lens barrel of collapsible type camera using the zoom lens according to an embodiment of the invention;

FIGS. 18 and 19 are a schematic front view and a schematic side view of the appearance of a collapsible type camera, respectively, for the purpose of explaining the issue in the collapsible type camera; and

FIG. 20 shows a block diagram showing an image pickup apparatus according to an embodiment of the present invention.

### DETAILED DESCRIPTION OF THE EMBODIMENTS

Embodiments for practicing the zoom lens and the image pickup apparatus according to an illustrative embodiment of the present invention will be described with reference to the accompanying drawings.

Firstly, the zoom lens of an embodiment of the present invention will be described below.

The zoom lens of an embodiment of the present invention includes a first lens group having a negative refractive power, a second lens group having a positive refractive power and a third lens group having a positive refractive power, the first, second, and third lens groups being arranged in this order from an object side. When a lens position state changes from a maximum wide angle state to a maximum telephoto state, all of the lens groups are moved in an optical axis direction and at least the second lens group moves to the object side, and the third lens group moves to an image side so that a distance between the first lens group and the second lens group decreases and a distance between the second lens group and the third lens group increases. When a subject position changes, the third lens group moves to perform close-distance focusing. The first lens group is composed of a negative lens component whose concave surface is directed to the image side and image side lens surface is aspheric, and a positive lens component of meniscus shape whose concave surface is directed to the image side, the positive lens component being arranged on the image side of the negative lens component with air space therebetween. The second lens group is composed of a positive lens component, and a cemented lens composed of a positive lens of biconvex shape and a negative lens of biconcave shape, the cemented lens being arranged on the image side of the positive lens component with air space therebetween. The third lens group is composed of a positive lens component where at least one of an object-side lens surface and an image-side lens surface is aspheric. The zoom lens satisfies the following conditional expression (1): 0.12<φ24·fw<0.22, where φ24 is a refractive power of a cemented surface of the cemented lens arranged in the second lens group, and defined by the following equation: φ24=(n5−n4)/R24 (n5<n4), where n5 is a refractive index with respect to a d-line (having a wavelength of 587.6 nm) of the negative lens composing the cemented lens arranged in the second lens group; n4 is a refractive index with respect to a d-line of the positive lens composing the cemented lens arranged in the second lens group; R24 is a curvature radius of the cemented surface of the cemented lens arranged in the second lens group; and fw is a focal length of the entire lens system in the maximum wide angle state.

The above-described zoom lens may contribute to miniaturize the camera body.

When the lens position state changes from the maximum wide angle state to the maximum telephoto state, the distance between the first and second lens groups decreases, so that the transverse magnification of the second lens group changes, so that the focal length of the entire lens system changes. The third lens group moves in the optical axis direction, providing excellent correction of variations in image surface distortion aberration caused when the lens position state changes.

Moving the third lens group at the time of close-distance focusing enables simplification of the lens barrel structure. This is because the third lens group has a small lens diameter.

The negative-positive-positive 3-group zoom lens has often been used in so-called collapsible type cameras where the lens groups are housed in the camera body so as to minimize the distance between the respective lens groups.

The zoom lenses for use in these collapsible type cameras are required to reduce both the lens group thickness and the entire lens length for the purposes of reducing the camera body thickness. That is, in the collapsible type cameras, the lens barrels holding the lenses are moved in the optical axis direction, and when these are collapsed, the respective lens barrels are in an overlying relation with each other, and then housed in the main body.

In the zoom lens of an embodiment of the present invention, as will be described later, owing to a large range of negative values in the transverse magnification of the second lens group, the entire lens length in the maximum wide angle state can be reduced as compared to a heretofore used one.

However, a mere change in the transverse magnification of the second lens group may cause the following problems that the angle of view in the maximum wide angle state may be narrowed; the entire lens length in the maximum telephoto state may be larger than that of the conventional one; and the distance between the first and second lens groups may not be ensured sufficiently in the maximum telephoto state. An easier way to solve the problems is to increase the refractive power of the first and second lens groups. This however causes the following new problems that the optical performance may be considerably deteriorated due to manufacturing error generated during the manufacture; and the off-axis aberration generated along with changes in the angle of view in the maximum wide angle state may be increased.

With this in view, the abovementioned problems may be solved, and the influence of assembly error or the like during manufacturing may be minimized by the following lens configuration and by paying attentions to each of the following two points. The configuration is such the first lens group is composed of two lenses of a negative lens L11 and a positive lens L12, and the image side lens surface of the negative lens L11 is aspheric. The second lens group is composed of a positive lens L21 and a cemented negative lens L22 composed of a positive lens and a negative lens. The third lens group is composed of a positive lens L3. The first point is that the third lens group is moved to the image side when the lens position state changes from the maximum wide angle state to the maximum telephoto state. The second point is that the refractive power of the cemented surface is set properly.

Specifically, the first lens group has the tablet configuration composed of the negative lens L11, and the positive lens L12 arranged on the image side of the negative lens L11 with air space therebetween. This enables excellent corrections of on-axis aberration and off-axis aberration. Further, an aspheric surface is used for the image side lens surface of the negative lens L11, so that variations in the coma aberration along with changes in the angle of view, which especially tends to generate in the maximum wide angle state, may be corrected well.

The second lens group is composed of the positive lens L21, and the cemented lens L22 which is composed of the positive lens and the negative lens, and arranged on the image side of the positive lens L21 with air space therebetween. This enables excellent correction of negative distortion aberration which tends to occur in the maximum wide angle state.

Especially, in order to prevent the optical performance deterioration due to a mutual slant between the positive lens L21 and the cemented lens L22 generated during the manufacture, the refractive index of the positive lens increases more than that of the negative lens in the cemented lens L22, and the concave surface of the cemented surface is directed to the object side. This permits a positive refractive power to relax the curvature radius of the object side lens surface of the positive lens. Setting that the concave surface of the cemented surface is directed to the object side can also suppress occurrence of off-axis aberration on the cemented surface.

The third lens group is composed of the positive lens L3. At least one of the object side lens surface and the image side lens surface of the positive lens L3 may be aspheric. This enables excellent correction of variations in coma aberration, which is especially generated along with changes in the angle of view in the maximum telephoto state.

Additionally, by arranging the third lens group so as to be separated from the image surface in the maximum wide angle state, the occurrence of negative distortion aberration may be suppressed. Further, when the lens position state changes from the maximum wide angle state to the maximum telephoto state, the third lens group is moved to the image side, and the change in the height of the off-axis light passing through the third lens group can be used to make an excellent correction of variations in the off-axis aberration along with the changes in the lens position state.

Although it may be considered to reduce the entire lens length not only in the maximum wide angle state but also in the maximum telephoto state, the refractive power of the respect lens groups may be further increased, and the influence of the assembly error or the like during manufacturing increases, making it difficult to ensure stable optical quality. Hence, in the zoom lens of an embodiment of the invention, a principal objective is to reduce the entire lens length in the maximum wide angle state.

Preferably, an aperture stop is disposed between the first and second lens groups, and moved integrally with the second lens group when the lens position state changes. This enables the aperture stop to be arranged on the image side of the first lens group. Therefore, the concave surface of the image side lens surface of the negative lens L11 is directed to the image side, and the concave surface of the image side lens surface of the positive lens L12 is directed to the image side, enabling excellent correction of the off-axis aberration generated in the maximum wide angle state. In the maximum wide angle state, the off-axis light passing through the first lens group passes apart from the optical axis, thus enabling the off-axis aberration and the on-axis aberration to be corrected individually. Additionally, when the lens position state changes from the maximum wide angle state to the maximum telephoto state, the distance between the first lens group and the aperture stop is reduced, so that the off-axis light passing through the first lens group may get close to the optical axis. This enables excellent correction of variations in the off-axis aberration generated when the lens position state changes.

The conditional expression (1) is for defining the refractive power of the cemented surface of the cemented lens L22 arranged in the second lens group.

There has been a significant problem on performance deterioration due to the mutual slant between the positive lens and the cemented negative lens when the second lens group is composed of a positive lens and a cemented negative lens composed of a positive lens and a negative lens. Where R21 is an object side lens surface composing the positive lens; R22 is an image side lens surface; R23 is an object side lens surface composing a cemented lens; R24 is a cemented surface; and R25 is an image side lens surface, the three lens surfaces R21, R22 and R23 have positive refractive power and perform convergence action, and the cemented surface R24 performs chromatic aberration correction action, and the lens surface R25 has a negative refractive power and performs a divergence action. Consequently, when the positive lens and the cemented lens cause mutual decentrating, only one of the three surfaces having convergence action will be moved, deteriorating optical performance. In particular, a strong convex surface of the object side lens surface R23 of the cemented lens is directed to the object side, thereby causing performance deterioration in the peripheral portions of the screen during decentrating.

With this in view, in the zoom lens of an embodiment of the present invention, the refractive power of the object side lens surface decreases to suppress the optical performance deterioration due to mutual decentrating, by enhancing the positive refractive power of the cemented surface R24 of the cemented lens L22 performing mainly chromatic aberration correction.

With above the upper limit of the conditional expression (1), the refractive power of the cemented surface R24 is too enhanced, causing high-order negative spherical aberration and deteriorating optical performance. It becomes necessary to increase central thickness so that the positive lens can be subjected to polishing process and surface grinding process. This is contrary to miniaturization.

When below the lower limit of the conditional expression (1), as mentioned previously, the positive refractive power of the cemented surface R24 is weakened, and the refractive power of the object side lens surface R23 of the cemented lens L22 is enhanced. This increases the optical performance deterioration due to the mutual slant between the positive lens L21 and the cemented lens L22 generated during the manufacture, making it difficult to obtain stable optical performance.

In the zoom lens according to an embodiment of the present invention, in order to suppress the off-axis aberration in the maximum wide angle state, and further improve optical performance, it is desirable to satisfy the following conditional expression (2) for defining the shape of the positive lens L12 in the first lens group.

0.25<fw/r22<0.32 (2)

where r22 is the curvature radius of the image side lens surface of the positive lens component L12 arranged in the first lens group.

When below the lower limit of the conditional expression (2), the negative curvature of field generated in the maximum wide angle state in the positive lens L12 is too large, making it difficult to achieve higher performance.

Conversely, when above the upper limit value of the conditional expression (2), the principal point position of the positive lens L12 is moved to the image side. This causes undesired increasing of the entire lens length.

In the zoom lens according to an embodiment of the present invention, in order to achieve higher image quality by more suitably correcting the on-axis aberration in the maximum wide angle state, it is desirable to satisfy the following conditional expression (3) for defining the shape of the positive lens L21 arranged in the second lens group.

−0.5<(r31+r32)/(r31−r32)<−0.3 (3)

where r31 is the curvature radius of the object side lens surface of the positive lens component L21 arranged in the second lens group, and r32 is the curvature radius of the image side lens surface of the positive lens component L21 arranged in the second lens group.

When above the upper limit of the conditional expression (3), the convergence action by the object side lens surface of the positive lens L21 is weakened, and the principal point position of the second lens group is moved to the image side, making it difficult to reduce the entire lens length.

Conversely, when below the lower limit value of the conditional expression (3), the convergence action by the object side lens surface of the positive lens L21 is enhanced, resulting in insufficient correction of the negative spherical aberration.

Although the negative spherical aberration may also be suitably corrected by making the object side lens surface of the positive lens L21 into an aspheric, the curvature of the image side lens surface of the negative lens is enhanced as the curvature of the object side lens surface of the positive lens L21 is enhanced. As a result, the positive spherical aberration generated in the cemented lens L22 increases. This makes it difficult to avoid the optical performance deterioration due to the mutual decentering between the positive lens L21 and the cemented lens L22, making it difficult to achieve higher image quality.

In the zoom lens according to an embodiment of the present invention, in order to reduce the entire lens length in the maximum wide angle state, it is desirable to satisfy the following conditional expression (4) for defining the transverse magnification of the second lens group.

1.3<β2w·β2t<1.5 (4)

where β2w is the transverse magnification of the second lens group in the maximum wide angle state, and β2t is the transverse magnification of the second lens group in the maximum telephoto state.

When below the lower limit of the conditional expression (4), the entire lens length in the maximum wide angle state may not be sufficiently reduced.

When above the upper limit of the conditional expression (4), the transverse magnification of the second lens group in the maximum telephoto state is too large, leading to extremely high stop accuracy in the optical axis direction of the first lens group and the second lens group. The enhanced stop accuracy may cause the image position to be moved in the optical axis direction even by a stop error caused by an assembly error during manufacturing. Therefore, the detection accuracy of a focus position is lowered, which leads to image blur.

In the zoom lens according to an embodiment of the present invention, in order to realize further miniaturization, it is desirable to satisfy the following conditional expression (5) for defining the focal length of the third lens group.

1.8<f3/fw<3 (5)

where f3 is the focal length of the third lens group.

When above the upper limit value of the conditional expression (5), the moving amount of the third lens group required at the time of close-distance focusing is too large to ensure sufficient distance between the second and third lens groups when the subject position approaches in the maximum wide angle state.

When below the lower limit value of the conditional expression (5), the off-axis light passing through the third lens group is apart from the optical axis, and the lens diameter of the third lens group is too large, thereby to hinder the miniaturization.

As described above, the zoom lens according to embodiments of the present invention enable reductions in the entire length, particularly, in the entire length and miniaturization in the maximum wide angle state. Accordingly, these zoom lenses are suitable for use in the so-called collapsible type cameras, thus contributing to thickness reduction and profile reduction of the camera body.

The collapsible type cameras will be described briefly.

As previously described, the negative-positive-positive 3-group zoom lens has often been used in the so-called collapsible type cameras where the lens groups are housed in the camera body so as to minimize the distance between the respective lens groups.

To reduce a thickness of the camera body, the zoom lenses used in these collapsible type cameras are required to reduce the lens thickness and the entire lens length. This is because the lens barrels for holding the lenses and moving them in the optical axis direction are composed of a plurality of barrels, and housed in the main body so that the respective lens barrels stack one upon another when these are collapsed.

In the known configuration, to reduce a thickness of the camera body, the entire lens length in the maximum wide angle state is arranged so as to be almost the same as that of the maximum telephoto state, and when the lens position state changes from the maximum wide angle state to the maximum telephoto state, the first lens group is temporarily moved to the image side and then moved to the object side.

When the transverse magnification of the second lens group is moved to the image side in the range of −1 to 0, and then becomes smaller than −1, the first lens group is moved to the object side. Accordingly, in the negative-positive-positive 3-group zoom lens, the position at which the transverse magnification of the second lens group becomes −1 is included midway where the lens position state changes from the maximum wide angle state to the maximum telephoto state.

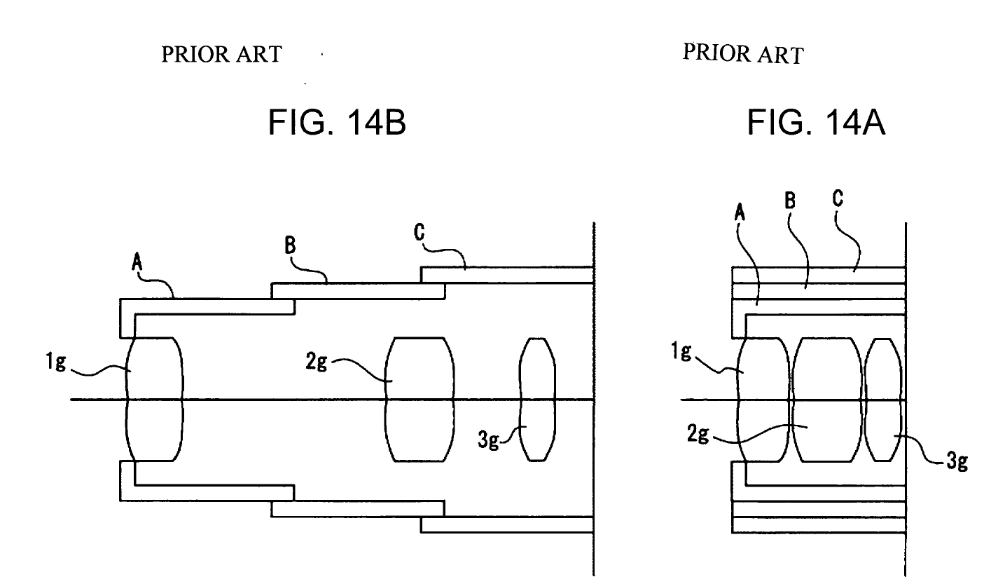

As a collapsible type structure, a two-stage collapsible type is known, as shown in FIGS. 14A and 14B, in which three lens barrels A (supporting a first lens group 1g), B (supporting a second lens group 2g) and C (supporting a third lens group 3g) are overlapped with each other, and the two lens barrels A and B are driven in the optical axis direction. FIGS. 14A and 14B illustrate the housing state and the use state, respectively.

The lens barrel B is rotationally driven and therefore movable in the optical axis direction along with a cam groove disposed between the lens barrels B and C, so that the lens barrel B can be extended in the optical axis direction from the collapsed state to the maximum wide angle state, and the lens barrel B may be secured in the optical axis direction from the maximum wide angle state to the maximum telephoto state. The lens barrel A can be moved in the optical axis direction along the cam groove disposed in the lens barrel B, so that the lens barrel A can be extended with respect to the lens barrel B from the collapsed state to the maximum wide angle state, and driven in the optical axis direction along a predetermined cam track from the maximum wide angle state to the maximum telephoto state. The second lens group 2g can be driven in the optical axis direction along a cam groove disposed in the internal wall of the lens barrel B.

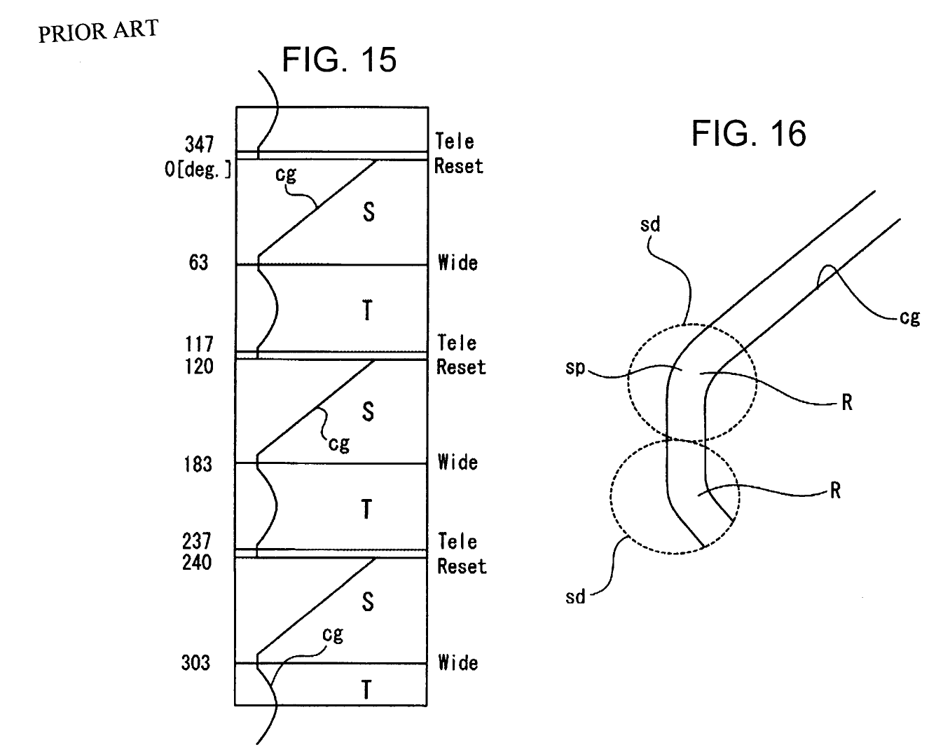

FIG. 15 is a schematic diagram showing a cam groove cg for driving the A-lens barrel arranged in the inner wall of the B-lens barrel. In this structure, cam pins (not shown) located at three positions in the outer periphery of the A-lens barrel, and the cam groove cg of the internal wall of the B-lens barrel are slidably engaged with each other. The A-lens barrel becomes unrotatable by slidable engagement between a linear groove extending back and forth, which is formed in a linear barrel (not shown) located on the inner side of the B-lens barrel, and the abovementioned cam pins. Therefore, the rotation of the inner wall of the B-lens barrel enables moving in the optical axis direction along the cam groove cg.

A zone S is a drive range when the power of the camera is turned on, in which the first lens group 1g is moved in the optical axis direction from the collapsed state (Reset position in FIG. 15) to the maximum wide angle state (Wide position in FIG. 15). A zone T is a zoom drive range in use, in which the first lens group 1g is moved in the optical axis direction from the maximum wide angle state (Wide position in FIG. 15) to the maximum telephoto state (Tele position).

As described above, the entire lens length in the maximum wide angle state has previously been almost the same as that of the maximum telephoto state, so that the moving amount of the first lens group from the collapsed state to the wide-angle end is large, thereby increasing the angle of rotation of the B-lens barrel. This is because an attempt to obtain a large moving amount at a less angle of rotation needs a large tilting angle of the cam groove, thus increasing the load for transferring torque as moving power in the optical axis direction.

Since it is difficult to increase the tilting angle of the cam groove cg over a certain angle, it becomes necessary to increase the outer diameter of the lens barrel B (that is, to increase the length in the vertical direction in FIG. 15), or increase the angle of rotation in the zone S.

Additionally, since the moving direction of the first lens group is reversed in the maximum wide angle state, it becomes forced to employ such a shape that a location sd having a sharp angle change is connected with a R, as shown in FIG. 16. With decreasing the rotation angle of the lens barrel B in the zone T, the tilting angle of the cam groove at a start position from which the maximum wide angle state changes to the maximum telephoto state becomes larger, thereby to increase the range of connecting with the R.

From the foregoing points, the collapsible type cameras using the known zoom lens requires a very large load for rotating the lens barrels and moving the first lens group 1g in the optical axis direction. As a result, it is difficult to reduce power requirements or provide miniaturization.

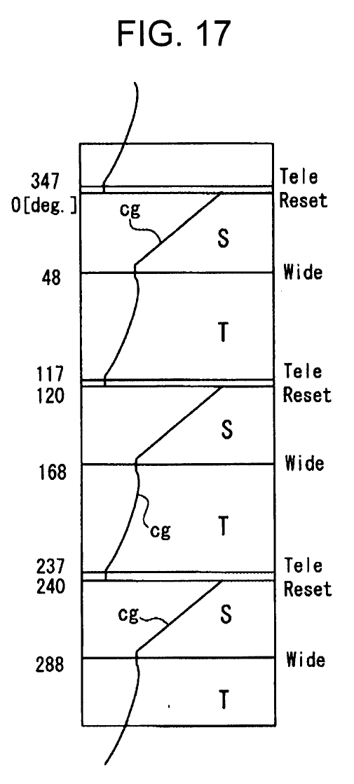

In the zoom lens of an embodiment of the present invention, as shown in FIG. 17, by reducing the entire lens length in the maximum wide angle state, the angle of rotation of the B-lens barrel in the zone S can be reduced, permitting reductions in the tilting angle of the cam groove cg at the start portion from which the maximum wide angle state changes to the maximum telephoto state. Therefore, the load for rotating the lens barrel is reduced, and the barrel diameter of the B-lens barrel is also reduced by the reduction in the tilting angle of the cam groove cg. This permits power reduction and miniaturization.

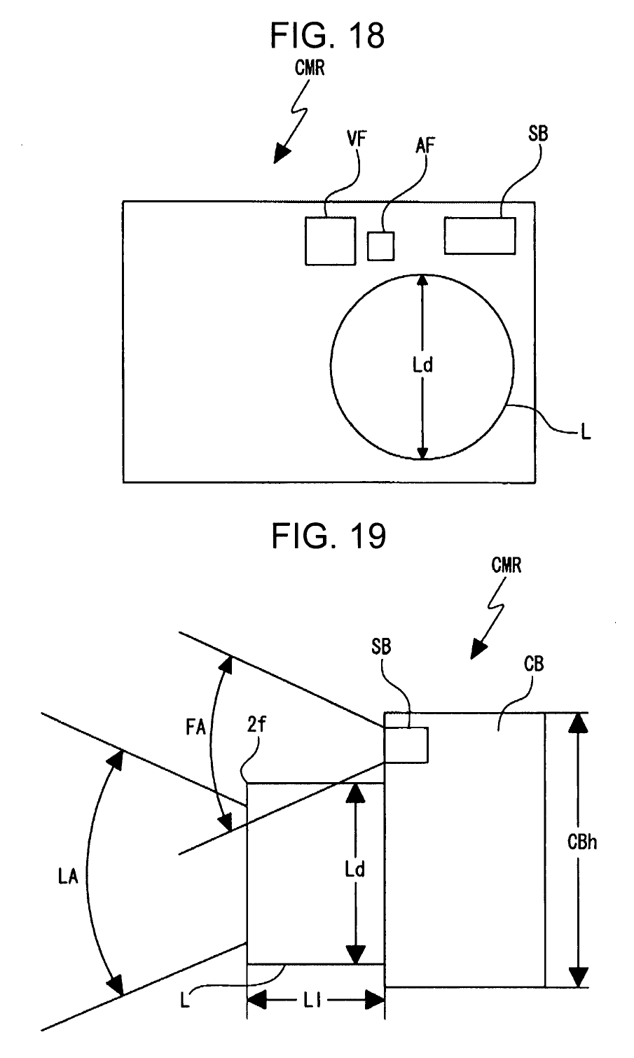

The influence of the entire lens length in the maximum wide angle state on the camera height will next be described. FIG. 18 is a front view of a camera body, and FIG. 19 is a side view of the camera body, in which the lens position state is the maximum wide angle state.

As shown in FIG. 19, a photo-taking range LA in the vertical direction of a photo-taking lens L is nearly matched with a view range FA in the vertical direction of a finder VF. Although it is effective to bring the finder VF near the photo-taking lens L when a height CBh of the camera body CB is lowered, a barrel front end Lf of the photo-taking lens L is entered into the view range FA, and hence there is a limit in reducing the height CBh of the camera body CB.

A camera CMR also has, besides the finder Vf, a illumination system having an illumination range corresponding to the photo-taking range of the camera CMR, such as a stroboscope SB and an auxiliary flash AF for auto focus. Even for the camera having no finder VF, there is a limit in the camera height.

As a specific method of lowering the height CBh of the camera CMR, it may be considered to reduce the barrel diameter Ld of the photo-taking lens L, or alternatively reduce the entire lens length L1 in the maximum wide angle state having a wide-angle of view.

With reducing the lens barrel diameter Ld, the third lens group has a limitation in miniaturization because of the limited exit pupil position. The first lens group has a limitation in miniaturization because of the angle of view, which is easy to use for users in the maximum wide angle state. The second lens group has a limitation in miniaturization because of F values in an open F value being easy to use for users under the determined angle of view. Although there are means for achieving further miniaturization such as reductions in the number of lens composing the respective lens group, higher performance is required as high pixel density is advanced. It is therefore desirable to ensure the necessary minimum number of lenses, making it difficult to expect any outstanding improvement.

Consequently, the zoom lenses according to an embodiment of the present invention address reductions in the entire lens length in the maximum wide angle state.

In the known zoom lenses, when the lens position state changes from the maximum wide angle state to the maximum telephoto state, as described above, the entire lens length at the wide-angle end is almost the same as that of the telephoto end. Accordingly, β21w·β21t≈1, where β21w is the transverse magnification of the second lens group in the maximum wide angle state, and β21t is the transverse magnification of the second lens group in the maximum telephoto state.

In the zoom lenses according to an embodiment of the present invention, as described above, the entire lens length in the maximum wide angle state is reduced from before, by using the large range of negative values of the transverse magnification of the second lens group.

This enables the thickness reduction and low profile of the camera body in the collapsible type cameras.

In the zoom lens according to an embodiment of the present invention, the image may be shifted with less optical performance deterioration by shifting the whole of a certain lens group or a part of a certain lens group in the constituting lenses, in a direction substantially perpendicular to the optical axis.

This zoom lens capable of shifting the image may be combined with a detection system, an operation system and a drive system so as to function as a vibration proof camera, which corrects image blur occurred by camera shaking generated at the time of shutter release or the like.

The detection system detects the blur angle of the camera and outputs camera shaking information. Based on the camera shaking information, the operation system outputs lens position information needed for reducing the camera shaking. Based on the lens position information, the drive system supplies a drive amount to a shift lens group.

The zoom lens according to an embodiment of the present invention uses an aspherical surface. The aspherical lens may be a glass mold lens, a compound lens in which a thin aspherical layer made of resin is transferred onto a polished glass lens, or a plastic mold lens.

In the zoom lens according to an embodiment of the present invention, a low-pass filter may be arranged to prevent the occurrence of moiré fringe on the image side in the lens system, and an infrared cut filter may be arranged according to the spectral sensitivity characteristics of a light receiving element.

Next, specific embodiments of the zoom lens of the invention, and numeral examples in which specific numerical values are applied to the embodiments will be described with reference to the accompanying drawings and tables.

In each of the embodiments, an aspherical surface is introduced, and the aspherical shape is defined by the following equation.

x=cy²/(1+(1−(1+k)c²y²)^{1/2})+Ay⁴+By⁶+ . . .

where y is a height from the optical axis, x is an amount of sag, c is a curvature, k is a conic coefficient, and A, B, . . . are aspherical coefficients.

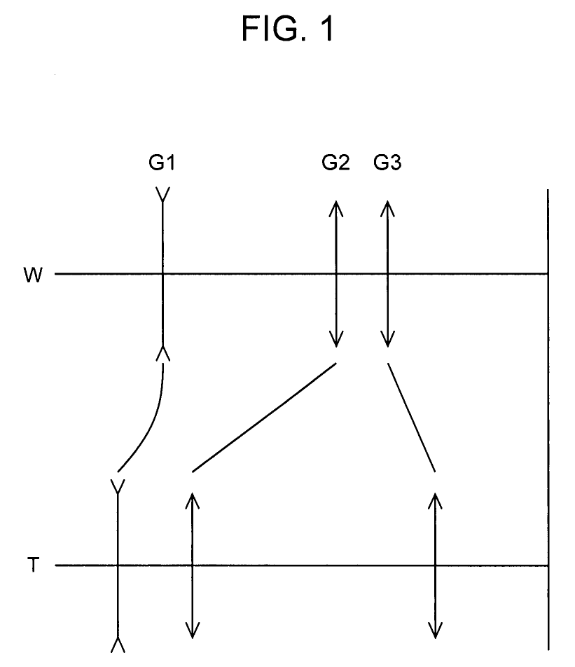

FIG. 1 shows the refractive power distribution of the zoom lenses of the respective embodiments of the present invention, which is configured by arranging, in order from an object side, a first lens group G1 having a negative refractive power, a second lens group G2 having a positive refractive power and a third lens group G3 having a positive refractive power. In zooming from the maximum wide angle state to the maximum telephoto state, all of the lens groups are moved so that the air space between the first lens group G1 and the second lens group G2 decreases, and the air space between the first lens group G1 and the third lens group G3 increases. At this time, the first lens group G1 is temporarily moved to the image side and then moved to the object side, the second lens group G2 is moved to the object side, and the third lens group G3 is moved to the image side. The third lens group G3 is moved so as to compensate image surface position variations along with the movement of the respective lens groups. The third lens group G3 is also moved to the object side at the time of close-distance focusing.

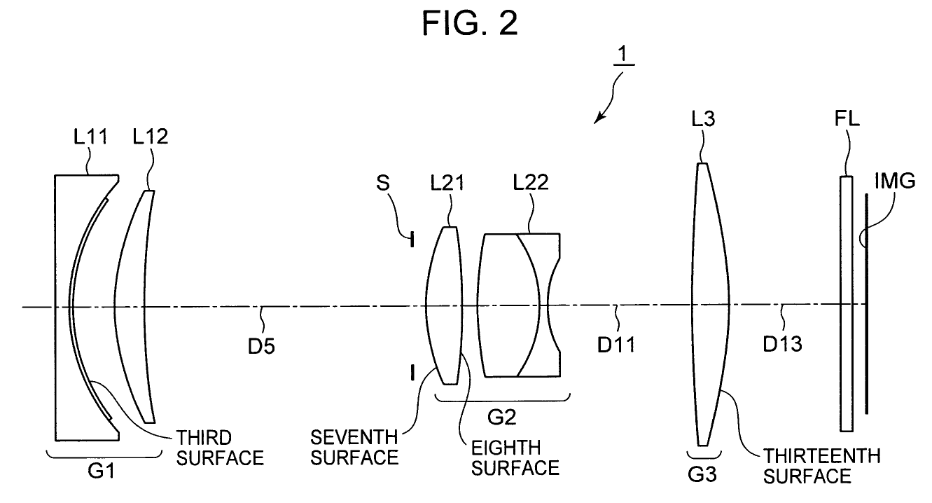

FIG. 2 shows the lens configuration of a zoom lens 1 according to a first embodiment of the present invention. A first lens group G1 is configured by arranging, in order from an object side to the image side, a negative lens L11 whose concave surface is directed to the image side, and a positive lens L12 of meniscus shape whose convex surface is directed to the object side. A second lens group G2 is configured by arranging, in order from the object side to the image side, a positive lens L21 of biconvex shape and a cemented negative lens L22 composed of a positive lens of biconvex shape and a negative lens of biconcave shape. A third lens group G3 is composed of a positive lens L3 of biconvex shape. The negative lens L11 of the first lens group G1 is a compound lens in which a thin aspherical resin layer made of plastic is laminated on the image side lens surface. An aperture stop S is located adjacent to the object side of the second lens group G2. In zooming from the maximum wide angle state to the maximum telephoto state, the aperture stop S is moved together with the second lens group G2. A filter FL is disposed between an image surface IMG and the third lens group G3.

Table 1 shows the lens data of a numerical example 1, in which specific numerical values are applied to the first embodiment. In Table 1 and the following tables showing other lens data, “surface number” indicates the i-th surface counted from the object side, “curvature radius” indicates the curvature radius of the i-th surface counted from the object side, “surface distance” indicates axial surface distance between the i-th surface and the (i+1)-th surface counted from the object side, “refractive index” indicates the refractive index against the d line of glass material having the i-th surface on the object side, and “Abbe number” indicates the Abbe number against the d line of glass material having the i-th surface on the object side. For example, “0.0000” in the curvature radius indicates that the surface is flat, and “(Di)” in the surface distance indicates that the surface distance is variable distance.

TABLE 1

| Surface | Radius of | Surface | Refractive | Abbe |
|---|---|---|---|---|
| Number | Curvature | Distance | Index | Number |
| 1: | 0.0000 | 0.071 | 1.88300 | 40.8 |
| 2: | 0.9913 | 0.013 | 1.53420 | 41.7 |
| 3: | 0.9135 | 0.251 | | |
| 4: | 1.4689 | 0.157 | 1.92286 | 20.8 |
| 5: | 3.3286 | (D5) | | |
| 6: | 0.0000 | 0.090 | | (Aperture |
| | | | | stop) |
| 7: | 0.9327 | 0.201 | 1.61881 | 63.9 |
| 8: | −2.3536 | 0.086 | | |
| 9: | 1.8722 | 0.336 | 1.83400 | 37.3 |
| 10: | −0.7610 | 0.052 | 1.71736 | 29.5 |
| 11: | 0.5695 | (D11) | | |
| 12: | 7.1400 | 0.201 | 1.77377 | 47.2 |
| 13: | −2.4621 | (D13) | | |
| 14: | 0.0000 | 0.103 | 1.51680 | 64.2 |
| 15: | 0.0000 | (Bf) | | |

The resin surface (the third surface) on the image side of the negative lens L11 of the first lens group G1, both surfaces (the seventh surface and the eighth surface) of the positive lens L21 of the second lens group G2, and the image side surface (the thirteenth surface) of the positive lens L3 of the third lens group G3 are each composed of an aspheric surface. Table 2 shows the fourth-order, the sixth-order, the eighth-order and the tenth-order aspherical coefficients A, B, C and D of the respective surfaces in the numeral example 1, together with each conic coefficient k. In Table 2 and the following tables showing aspherical coefficients, “E-i” is an exponential expression taking “10” as the bottom, namely indicates “10⁻ⁱ” For example, “0.12345E-05” indicates “0.12345×10⁻⁵”.

TABLE 2

| | | | | | |
|---|---|---|---|---|---|
| Third surface: | k = 0.00000 | A = −0.171398E+00 | B = +0.193059E−01 | C = −0.264773E+00 | D = −0.768007E−01 |
| Seventh surface: | k = 0.00000 | A = −0.241569E+00 | B = −0.386951E+00 | C = +0.852781E+00 | D = −0.377382E+01 |
| Eighth surface: | k = 0.00000 | A = +0.106028E+00 | B = −0.173016E+00 | C = +0.000000E+00 | D = +0.000000E+00 |
| Thirteenth surface: | k = 0.00000 | A = +0.120524E+00 | B = −0.326640E+00 | C = +0.650050E+00 | D = −0.504031E+00 |

In the zoom lens 1, at the zooming from the maximum wide angle state to the maximum telephoto state, a surface distance D5 between the first lens group G1 and the second lens group G2 (the aperture stop S), a surface distance D11 between the second lens group G2 and the third lens group G3, and a surface distance D13 between the third lens group G3 and the filter FL are changed. Table 3 shows the values in the maximum wide angle state (f=1.000), the middle focusing distance state (f=1.632) and the maximum telephoto state (f=2.825) of the abovementioned respective surface distance in the numeral example 1, together with each focusing distance f, each F number FNO and each angle of view 2ω.

TABLE 3

| f | 1.000~1.632~2.825 | | |
|---|---|---|---|
| FNO | 2.88~3.83~5.63 | | |
| 2ω | 64.66~40.03~23.64° | | |
| D5 | 1.467 | 0.731 | 0.240 |
| D11 | 0.785 | 1.563 | 2.870 |
| D13 | 0.489 | 0.419 | 0.285 |
| Bf | 0.170 | 0.170 | 0.170 |

Table 4 shows the numeric values for obtaining the respective conditions of the conditional expressions (1) to (5) in the numeral example 1, and the corresponding values of the respective conditional expressions.

TABLE 4

β2w = −0.742
β2t = −1.863
f3 = 2.388
(1) Φ24 · fw = 0.153
(2) fw/r22 = 0.300
(3) (r31 + r32)/(r31 − r32) = −0.432
(4) β2w · β2t = 1.383
(5) f3/fw = 2.388

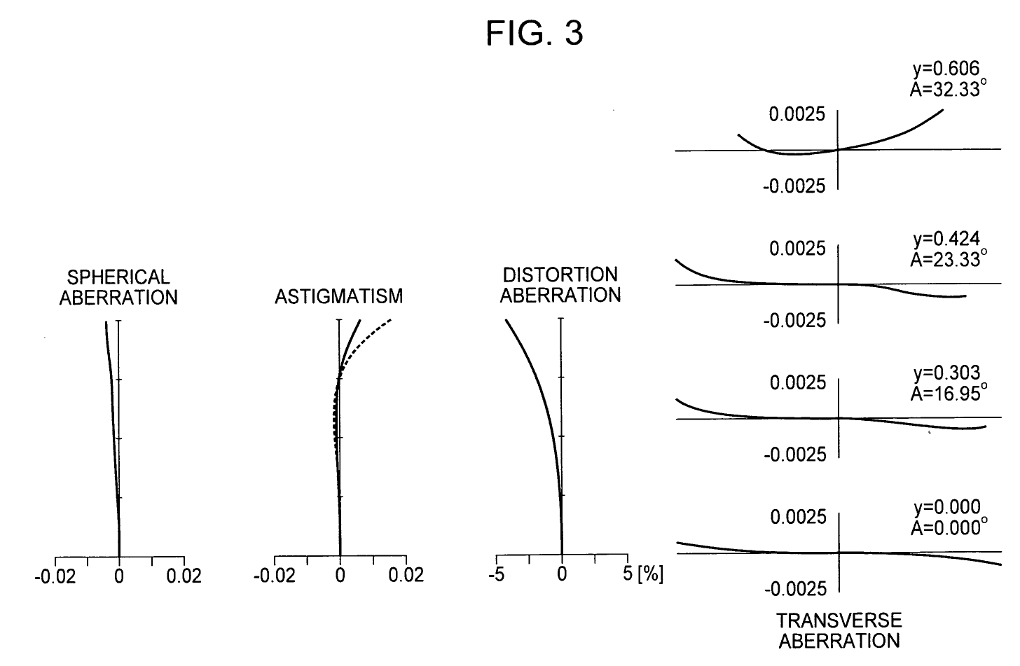

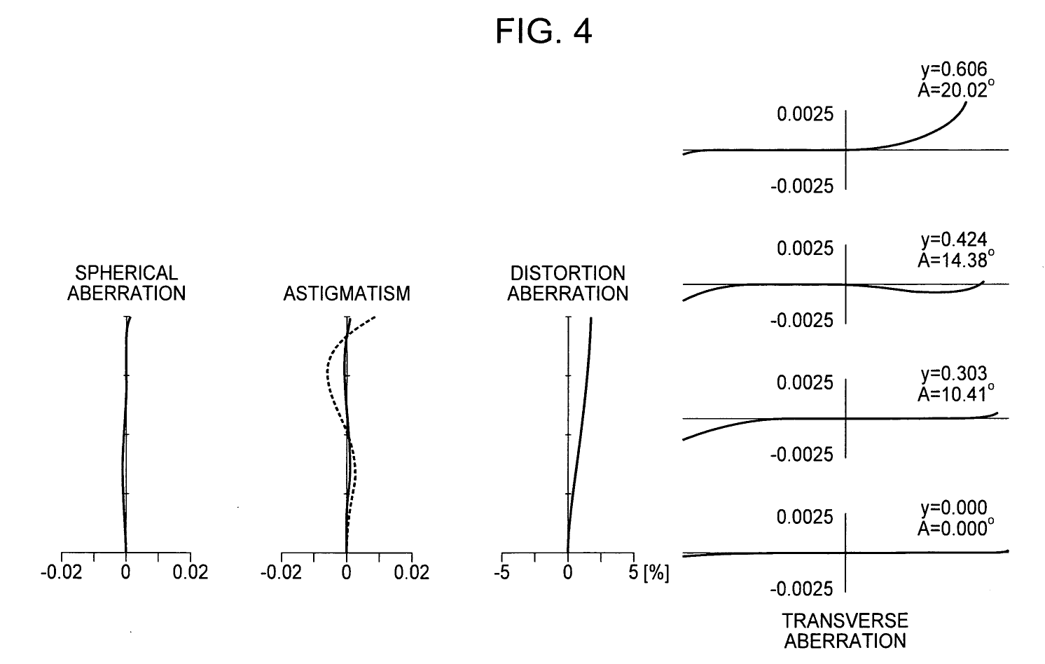

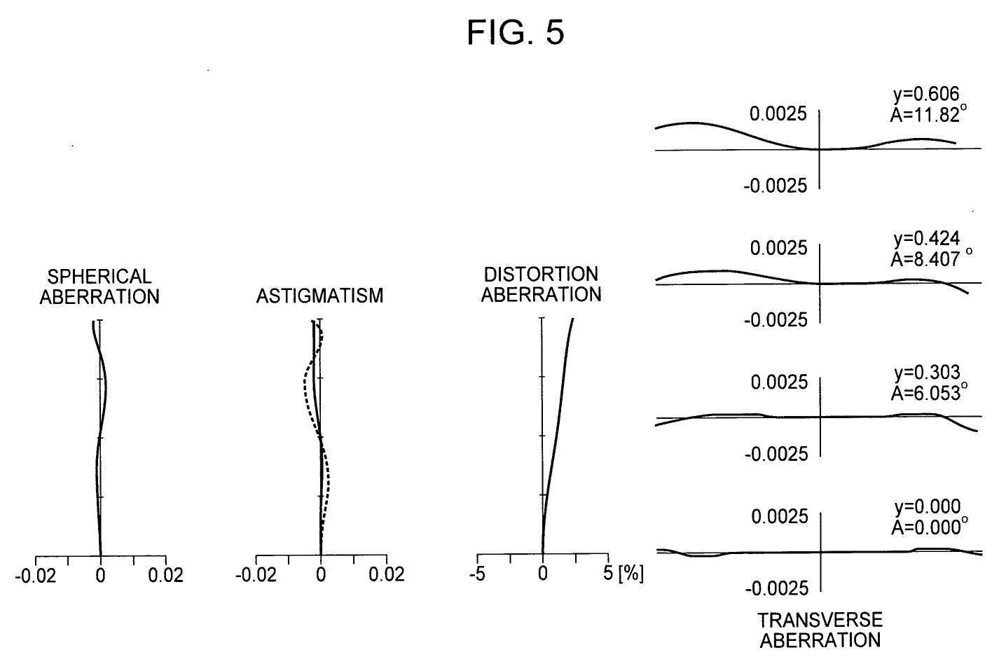

FIGS. 3 to 5 are graphs of various aberrations in the infinite remote focusing state of the numeral example 1. Specifically, FIG. 3 shows the various aberrations in the maximum wide angle state (f=1.000), FIG. 4 shows those in the middle focusing distance state (f=1.632), and FIG. 5 shows those in the maximum telephoto state (f=2.825).

In the respective aberration graphs of FIGS. 3 to 5, the solid line in the spherical aberration graph represents spherical aberration, and the solid line and the broken line in the astigmatic aberration graph represent sagittal image surface and meridional image surface, respectively. In the transverse aberration graphs, A represents an angle of view, and y represents an image height.

It can be seen from these respective aberration graphs that the numeral example 1 corrects the various aberrations favorably and has excellent image-forming performance.

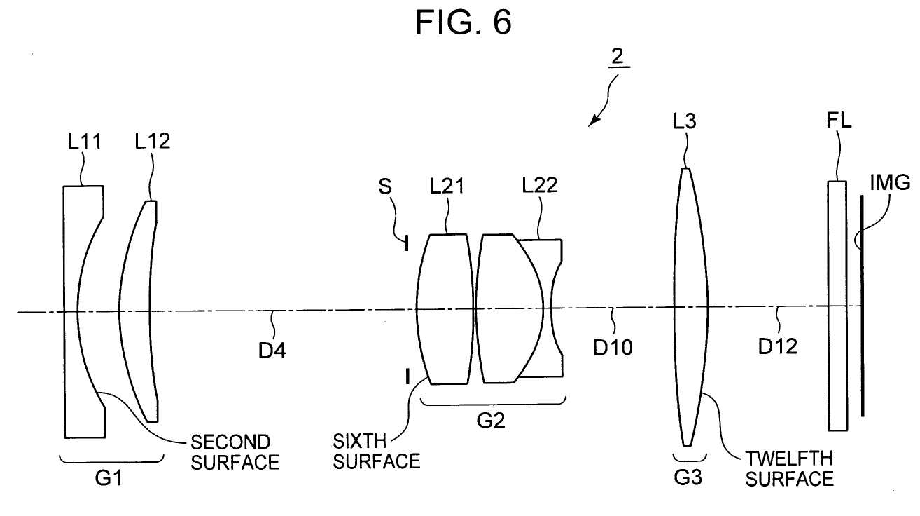

FIG. 6 shows the lens configuration of a zoom lens 2 according to a second embodiment of the present invention. A first lens group G1 is configured by arranging, in order from an object side to an image side, a negative lens L11 whose concave surface is directed to the image side, and a positive lens L12 of meniscus shape whose convex surface is directed to the object side. A second lens group G2 is configured by arranging, in order from the object side to the image side, a positive lens L21 of biconvex shape, and a cemented negative lens L22 composed of a positive lens of biconvex shape and a negative lens of biconcave shape. A third lens group G3 is composed of a positive lens L3 of biconvex shape. An aperture stop S is located adjacent to the object side of the second lens group G2. In zooming from the maximum wide angle state to the maximum telephoto state, the aperture stop S is moved together with the second lens group G2. A filter FL is disposed between an image surface IMG and the third lens group G3.

Table 5 shows the lens data of a numerical example 2, in which specific numerical values are applied to the zoom lens 2 according to the second embodiment.

TABLE 5

| Surface | Radius of | Surface | Refractive | Abbe |
|---|---|---|---|---|
| Number | Curvature | Distance | Index | Number |
| 1: | 0.0000 | 0.082 | 1.88300 | 40.8 |
| 2: | 0.9303 | 0.244 | | |
| 3: | 1.4943 | 0.163 | 1.92286 | 20.8 |
| 4: | 3.6108 | (D4) | | |
| 5: | 0.0000 | 0.088 | | (Aperture |
| | | | | stop) |
| 6: | 1.0545 | 0.309 | 1.61881 | 63.9 |
| 7: | −2.4099 | 0.013 | | |
| 8: | 1.4721 | 0.369 | 1.83400 | 37.3 |
| 9: | −0.6303 | 0.050 | 1.71736 | 29.5 |
| 10: | 0.5423 | (D10) | | |
| 11: | 5.7942 | 0.188 | 1.77377 | 47.2 |
| 12: | −3.0570 | (D12) | | |
| 13: | 0.0000 | 0.117 | 1.51680 | 64.2 |
| 14: | 0.0000 | (Bf) | | |

The image side surface (the second surface) of the negative lens L11 of the first lens group G1, the object side surface (the sixth surface) of the positive lens L21 of the second lens group G2, and the image side surface (the twelfth surface) of the positive lens L3 of the third lens group G3 are composed of an aspherical surface. Table 6 shows the fourth-order, the sixth-order, the eighth-order and the tenth-order aspherical coefficients A, B, C and D of the respective surfaces in the numeral example 2, together with each conic coefficient k.

TABLE 6

| | | | | | |
|---|---|---|---|---|---|
| Second surface: | k = −1.464827 | A = +0.104447E+00 | B = +0.177067E+00 | C = −0.599480E+00 | D = +0.729075E+00 |
| Sixth surface: | k = −0.912092 | A = −0.218992E+00 | B = −0.243218E+00 | C = +0.718317E+00 | D = −0.577169E+01 |
| Twelfth surface: | k = 0.00000 | A = −0.942987E−01 | B = +0.397661E+00 | C = −0.797949E+00 | D = +0.631424E+00 |

In the zoom lens 2, at zooming from the maximum wide angle state to the maximum telephoto state, a surface distance D4 between the first lens group G1 and the second lens group G2 (the aperture stop S), a surface distance D10 between the second lens group G2 and the third lens group G3, and a surface distance D12 between the third lens group G3 and the filter FL change. Table 7 shows the values in the maximum wide angle state (f=1.000), the middle focusing distance state (f=1.702) and the maximum telephoto state (f=2.826) of the respective surface distances in the numerical example 2, together with each focusing distance f, each F number FNO and each angle of view angle 2ω.

TABLE 7

| f | 1.000~1.702~2.826 | | |
|---|---|---|---|
| FNO | 2.88~4.03~5.75 | | |
| 2ω | 63.68~38.35~23.64° | | |
| D4 | 1.377 | 0.672 | 0.202 |
| D10 | 0.667 | 1.630 | 2.802 |
| D12 | 0.559 | 0.378 | 0.265 |
| Bf | 0.164 | 0.164 | 0.164 |

Table 8 shows the numeric values for obtaining the respective conditions of the conditional expressions (1) to (5) in the numeral example 2, and the corresponding values of the respective conditional expressions.

TABLE 8

β2w = −0.747
β2t = −1.810
f3 = 2.611
(1) Φ24 · fw = 0.185
(2) fw/r22 = 0.277
(3) (r31 + r32)/(r31 − r32) = −0.391
(4) β2w · β2t = 1.352
(5) f3/fw = 2.611

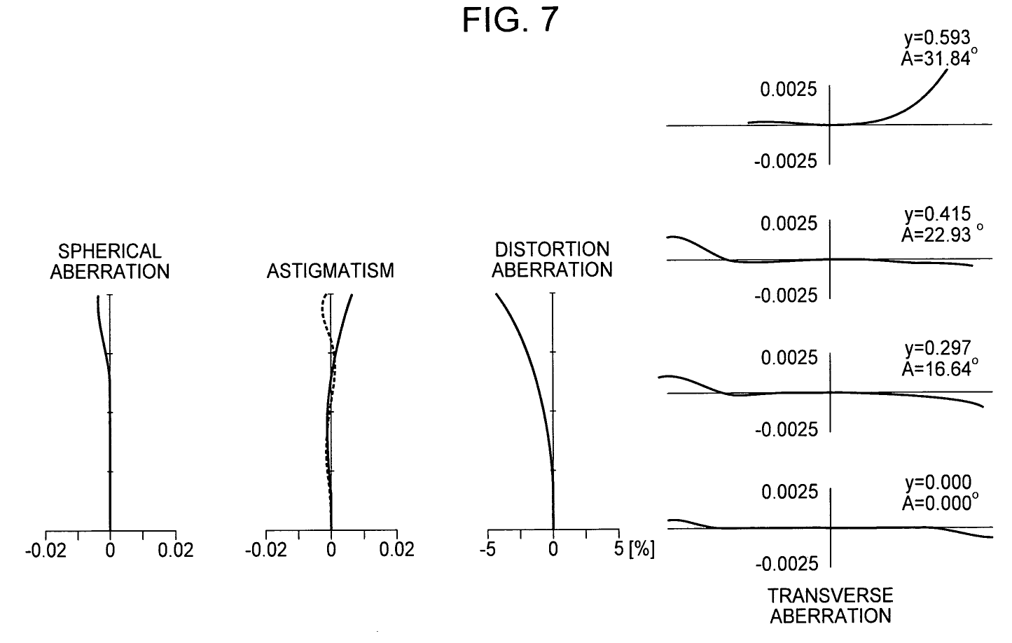

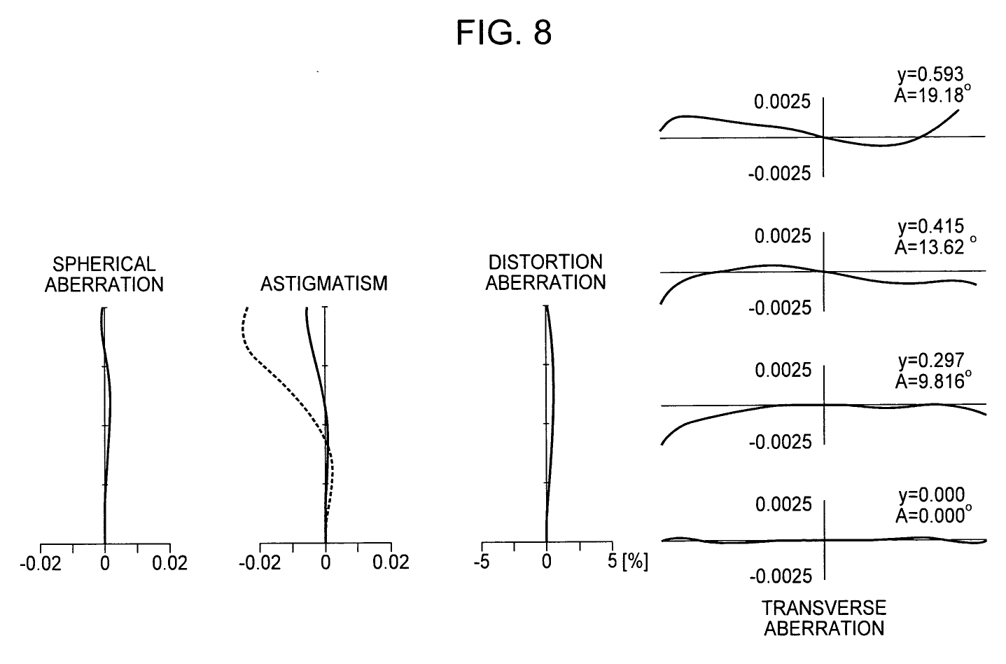

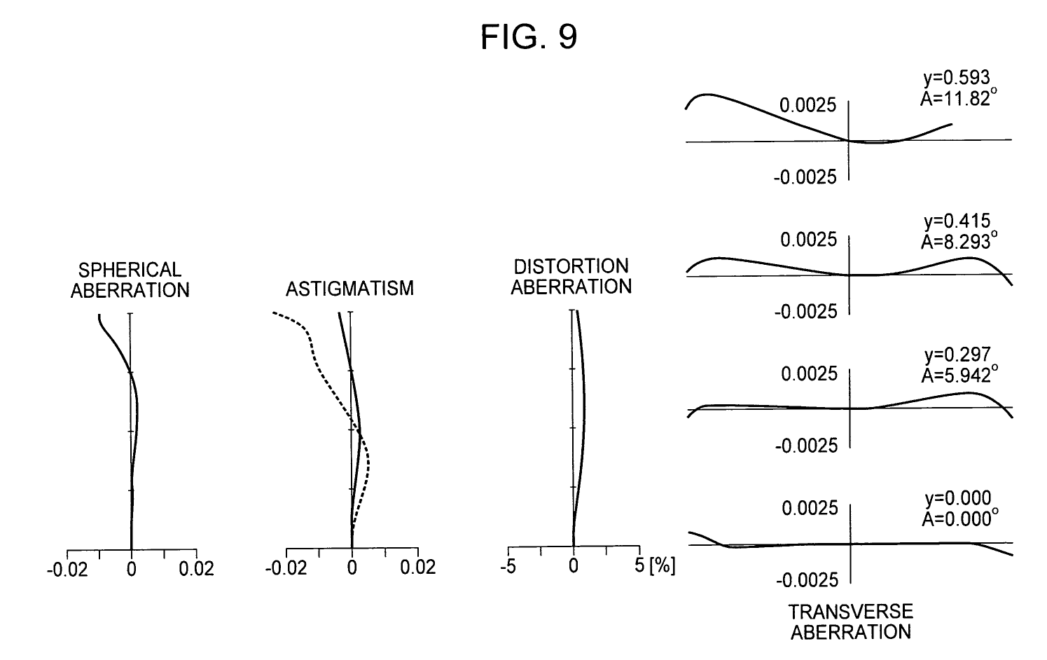

FIGS. 7 to 9 are graphs of various aberrations in the infinite remote focusing state of the numeral example 2. Specifically, FIG. 7 shows the various aberrations in the maximum wide angle state (f=1.000), FIG. 8 shows those in the middle focusing distance state (f=1.702), and FIG. 9 shows those in the maximum telephoto state (f=2.826).

In the respective aberration graphs of FIGS. 7 to 9, the solid line in the spherical aberration graph represents spherical aberration, and the solid line and the broken line in the astigmatic aberration graph represent sagittal image surface and meridional image surface, respectively. In the transverse aberration graphs, A represents an angle of view, and y represents an image height.

It may be seen from these respective aberration graphs that the numerical example 2 correct the various aberrations favorably and has excellent image-forming performance.

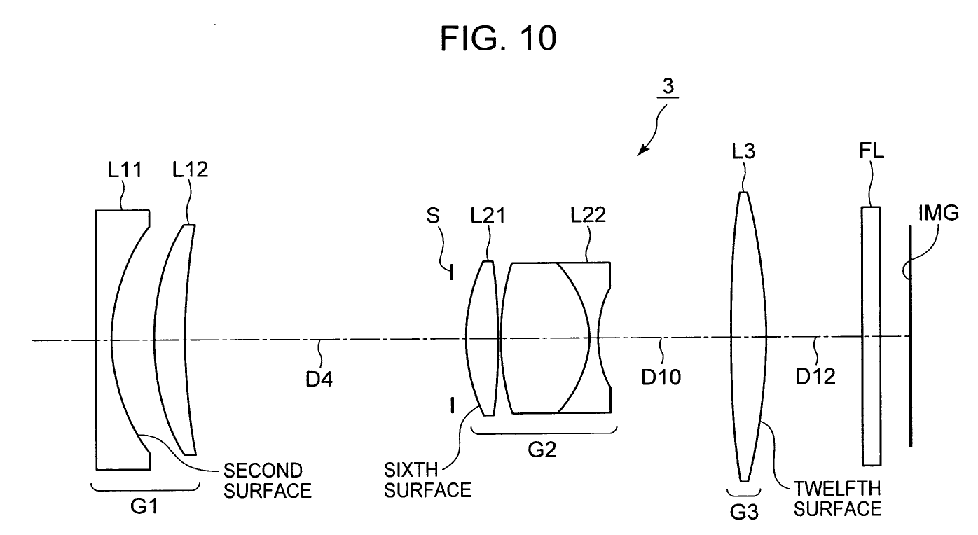

FIG. 10 shows the lens configuration of a zoom lens 3 according to a third embodiment of the present invention. A first lens group G1 is configured by arranging, in order from an object side to an image side, a negative lens L11 whose concave surface is directed to the image side, and a positive lens L12 of meniscus shape whose convex surface is directed to the object side. A second lens group G2 is configured by arranging, in order from the object side to the image side, a positive lens L21 of biconvex shape, and a cemented negative lens L22 composed of a positive lens of biconvex shape and a negative lens of biconcave shape. A third lens group G3 is composed of a positive lens L3 of biconvex shape. An aperture stop S is located adjacent to the object side of the second lens group G2. In zooming from the maximum wide angle state to the maximum telephoto state, the aperture stop S is moved together with the second lens group G2. A filter FL is disposed between an image surface IMG and the third lens group G3.

Table 9 shows the lens data of a numerical example 3, in which specific numerical values are applied to the zoom lens 3 according to the third embodiment.

TABLE 9

| Surface | Radius of | Surface | Refractive | Abbe |
|---|---|---|---|---|
| Number | Curvature | Distance | Index | Number |
| 1: | 0.0000 | 0.082 | 1.88300 | 40.8 |
| 2: | 0.9550 | 0.233 | | |
| 3: | 1.4850 | 0.155 | 1.92286 | 20.8 |
| 4: | 3.6271 | (D4) | | |
| 5: | 0.0000 | 0.088 | | (Aperture |
| | | | | stop) |
| 6: | 1.0509 | 0.175 | 1.61881 | 63.9 |
| 7: | −2.6369 | 0.013 | | |
| 8: | 1.6697 | 0.466 | 1.83400 | 37.3 |
| 9: | −0.6132 | 0.050 | 1.71736 | 29.5 |
| 10: | 0.5574 | (D10) | | |
| 11: | 4.8285 | 0.209 | 1.77377 | 47.2 |
| 12: | −2.7073 | (D12) | | |
| 13: | 0.0000 | 0.101 | 1.51680 | 64.2 |
| 14: | 0.0000 | (Bf) | | |

The image side surface (the second surface) of the negative lens L11 of the first lens group G1, the object side surface (the sixth surface) of the positive lens L21 of the second lens group G2, and the image side surface (the twelfth surface) of the positive lens L3 of the third lens group G3 are each aspheric surfaces. Table 10 shows the fourth-order, the sixth-order, the eighth-order and the tenth-order aspherical coefficients A, B, C and D of the respective surfaces in the numeral example 3, together with each conic coefficient k.

TABLE 10

| | | | | | |
|---|---|---|---|---|---|
| Second surface: | k = 0.00000 | A = −0.106109E+00 | B = +0.843253E−01 | C = −0.411705E+00 | D = +0.242015E+00 |
| Sixth surface: | k = 0.00000 | A = −0.302771E+00 | B = −0.156961E+00 | C = −0.805435E+00 | D = +0.220392E+00 |
| Twelfth surface: | k = 0.00000 | A = +0.108650E+00 | B = −0.353476E+00 | C = +0.778293E+00 | D = −0.649556E+00 |

At the zoom lens 3, in zooming from the maximum wide angle state to the maximum telephoto state, a surface distance D4 between the first lens group G1 and the second lens group G2 (the aperture stop S), a surface distance D10 between the second lens group G2 and the third lens group G3, and a surface distance D12 between the third lens group G3 and the filter FL change. Table 11 shows the values in the maximum wide angle state (f=1.000), the middle focusing distance state (f=1.702) and the maximum telephoto state (f=2.820) of the abovementioned respective surface distances in the numerical example 3, together with each focusing distance f, each F number FNO and each angle of view 2ω.

TABLE 11

| f | 1.000~1.702~2.820 | | |
|---|---|---|---|
| FNO | 2.88~4.03~5.75 | | |
| 2ω | 63.64~37.84~23.28° | | |
| D4 | 1.435 | 0.659 | 0.214 |
| D10 | 0.697 | 1.563 | 2.756 |
| D12 | 0.503 | 0.413 | 0.283 |
| Bf | 0.166 | 0.166 | 0.166 |

Table 12 shows the numeric values for obtaining the respective conditions of the conditional expressions (1) to (5) in the numerical example 3, and the corresponding values of the respective conditional expressions.

TABLE 12

β2w = −0.733
β2t = −1.802
f3 = 2.269
(1) Φ24 · fw = 0.190
(2) fw/r22 = 0.276
(3) (r31 + r32)/(r31 − r32) = −0.430
(4) β2w · β2t = 1.322
(5) f3/fw = 2.269

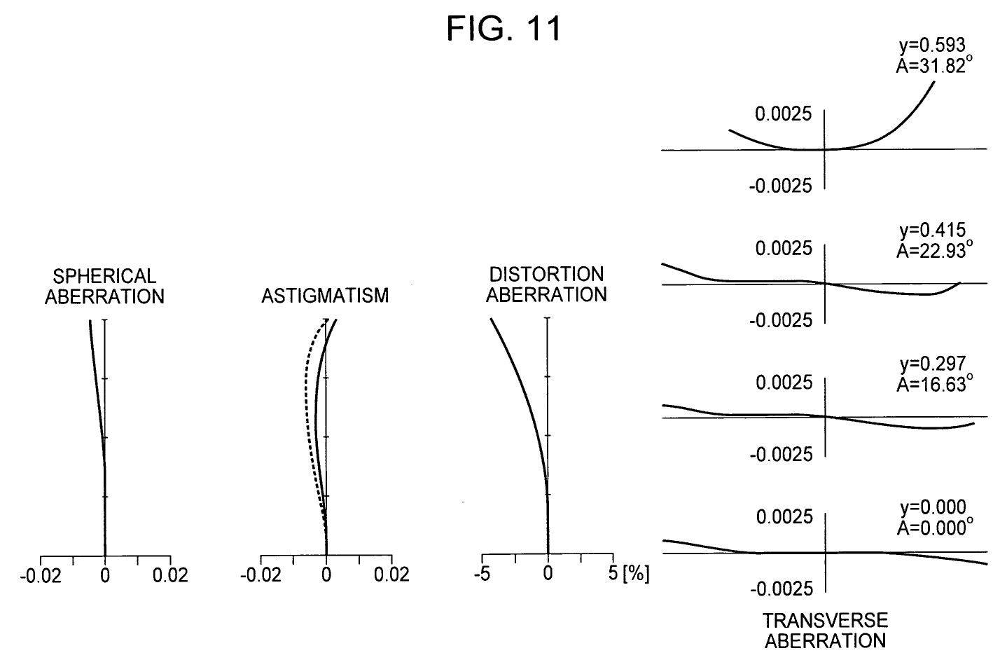

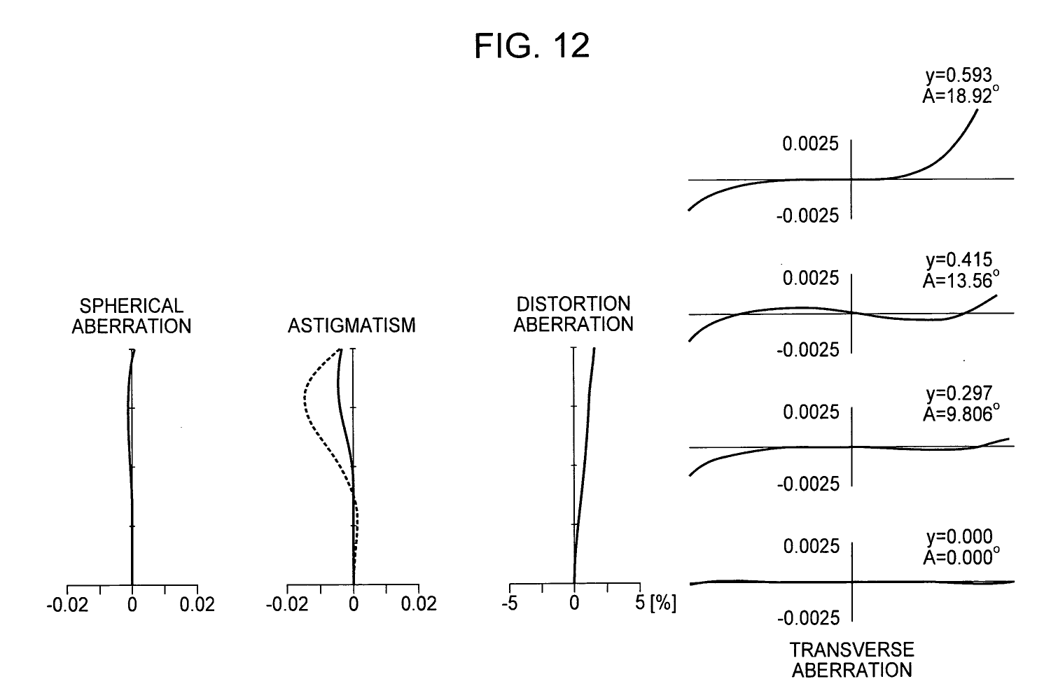

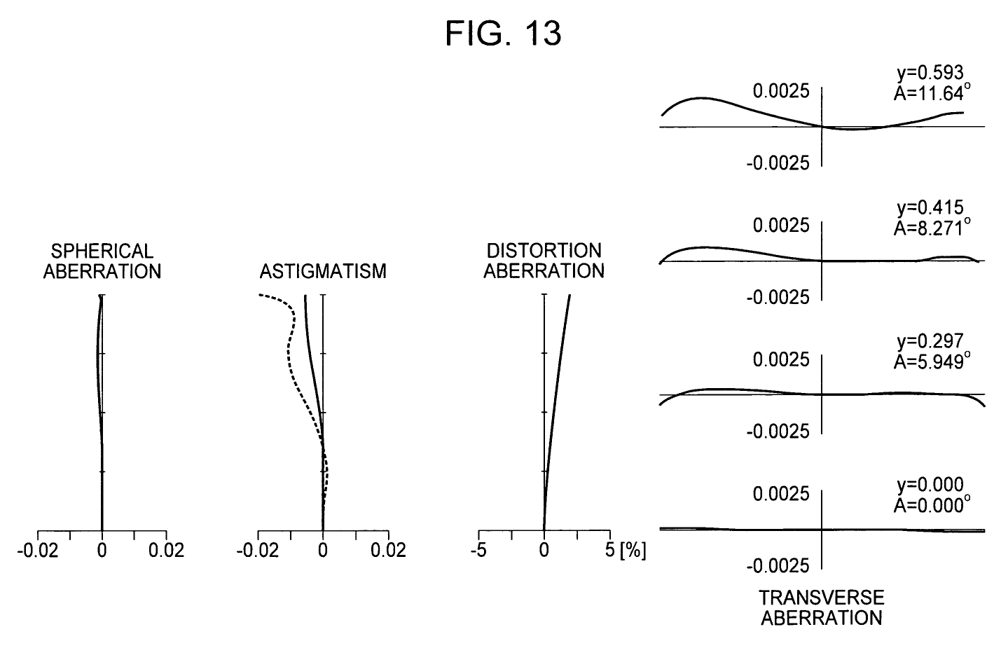

FIGS. 11 to 13 are graphs of various aberrations in the infinite remote focusing state of the numeral example 3. Specifically, FIG. 11 shows the various aberrations in the maximum wide angle state (f=1.000), FIG. 12 shows those in the middle focusing distance state (f=1.702), and FIG. 13 shows those in the maximum telephoto state (f=2.820).

In the respective graphs of FIGS. 11 to 13, the solid line in the spherical aberration graph represents spherical aberration, and the solid line and the broken line in the astigmatic aberration graph represent a sagittal image surface and a meridional image surface, respectively. In the transverse aberration graphs, A represents an angle of view, and y represents an image height.

It may be seen from these respective aberration graphs that the numeral example 3 corrects the various aberrations favorably and has excellent image-forming performance.

An image pickup apparatus of an embodiment of the present invention will next be described.

The image pickup apparatus includes a zoom lens and a solid image pickup element for converting an optical image formed by the zoom lens into an electrical signal. The zoom lens is configured by arranging, in order from an object side, a first lens group having a negative refractive power, a second lens group having a positive refractive power and a third lens group having a positive refractive power. When the lens position state changes from the maximum wide angle state to the maximum telephoto state, all of the lens groups are moved in an optical axis direction and at least the second lens group is moved to the object side, and the third lens group is moved to an image side so that distance between the first lens group and the second lens group decreases and distance between the second lens group and the third lens group increases. When the subject position changes, the third lens group is moved to perform close-distance focusing. The first lens group is composed of a negative lens component L11 whose concave surface is directed to the image side and image side lens surface is composed of an aspheric surface, and a positive lens component L12 of meniscus shape whose concave surface is directed to the image side, the positive lens component L12 being arranged on the image side of the negative lens component L11 with air space therebetween. The second lens group is composed of a positive lens component L21, and a cemented lens L22 composed of a positive lens of biconvex shape and a negative lens of biconcave shape, the cemented lens L22 being arranged on the image side of the positive lens component L21 with air space therebetween. The third lens group is composed of a positive lens component L3 in which at least one of an object-side lens surface and an image-side lens surface is aspheric. The following conditional expression (1) is satisfied:

0.12<φ24·fw<0.22 (1)

where φ24 is a refractive power of a cemented surface of the cemented lens arranged in the second lens group, and defined by the following equation:

φ24=(n5−n4)/R24 (n5<n4)

where n5 is a refractive index with respect to a d line (having a wavelength of 587.6 nm) of the negative lens composing the cemented lens arranged in the second lens group; n4 is a refractive index with respect to a d line of the positive lens composing the cemented lens arranged in the second lens group; R24 is a curvature radius of the cemented surface of the cemented lens arranged in the second lens group; and fw is a focal length of the entire lens system in the maximum wide angle state.

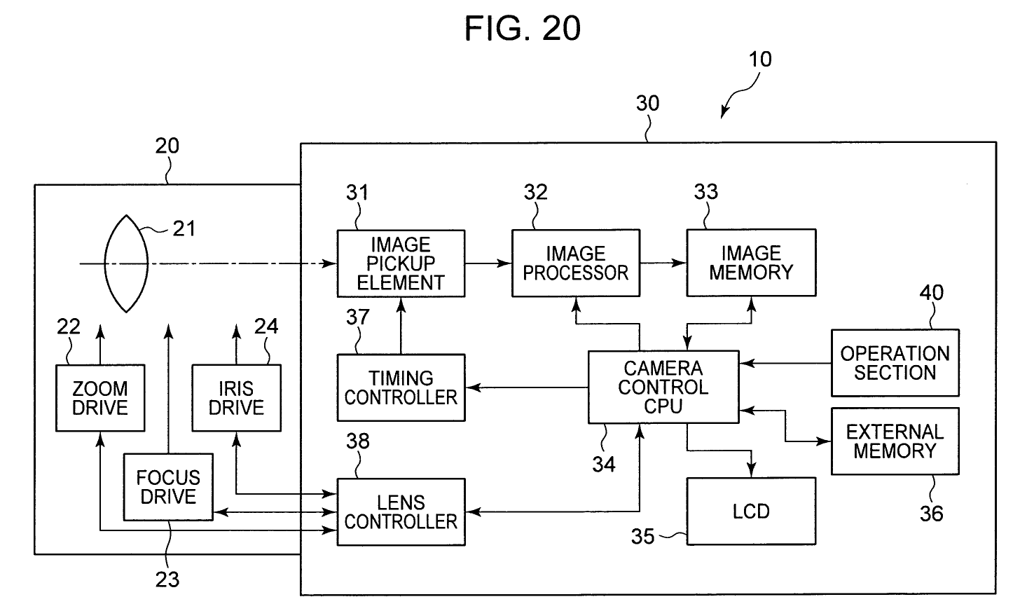

FIG. 20 is a block diagram of a digital still camera according to an embodiment of the image pickup apparatus of the present invention.

A digital still camera 10 includes a lens section 20 for optically capturing a subject image, and a camera body section 30 having the functions of converting the optical image of the object captured by the lens section 20 into electrical image signals, and performing various processing to the image signals and controlling the lens section 20.

The lens section 20 has a zoom lens 21 composed of optical elements such as lenses and a filter, a zoom drive section 22 for moving a variable-magnification optical system at the time of zooming, a focus drive section 23 for moving a focus group, and an iris drive section 24 for controlling the opening of an aperture stop. As the zoom lens 21, it is possible to use any one of the abovementioned zoom lenses 1 to 3, or alternatively the zoom lenses of an embodiment of the present invention embodied in their respective numeral examples, or embodiments other than the embodiments and numeral examples as shown previously.

The camera body section 30 includes an image pickup element 31 for converting the optical image formed by the zoom lens 21 into electrical signals.

As the image pickup element 31, a CCD, a CMOS or the like may be used. The electrical image signal outputted from the image pickup element 31 is subjected to various processing on an image processing circuit 32. The processed signal is then subjected to data compression in a predetermined mode, and temporarily stored as image data in an image memory 33.

A camera control CPU (central processing unit) 34 is for generally controlling the whole of the camera body section 30 and the lens section 20, and fetches the image data temporarily stored in the image memory 33, and displays the data on a liquid crystal display 35 and stored the data in an external memory 36. The camera control CPU 34 also reads the image data stored in the external memory 36, and displays the data on the liquid crystal display 35.

Signals from an operation section 40, such as a shutter release switch and a zooming switch, are inputted to the camera control CPU 34, and the respective sections are controlled based on the signals from the operation section 40. For example, when the shutter release switch is operated, an instruction is issued from the camera control CPU 34 to a timing controller 37, and the light from a zoom lens 21 is inputted to the image pickup element 31, and also the signal read timing of the image pickup element 31 is controlled by the timing controller 37.

Signals regarding to the control of the zoom lens 21, such as an AF (auto focus) signal, an AE (auto exposure) signal and a zooming signal, are sent from the camera control CPU 34 to a lens controller 38. The lens controller 38 controls the zoom drive section 22, the focus drive section 23 and the iris drive section 24, thereby bringing the zoom lens 21 into a predetermined state.

In the above embodiment, the image pickup apparatus is described as the digital still camera by way of example and without limitation. The image pickup apparatus is applicable to a digital video camera, or alternatively a camera section incorporated into information equipment such as personal computers and PDAs (personal digital assistants).

It should be understood that the shapes and numerical values of the respective sections shown and described in the foregoing embodiments are for purposes of illustration of mere embodiments for practicing embodiments of the present invention and are not be construed as limiting the technical scope of the present invention.

The present application claims benefit of priority of Japanese patent Application No. 2007-38303 filed in the Japanese Patent Office on Feb. 19, 2007, the entire contents of which are incorporated herein by reference.

What is claimed is:

1. A zoom lens comprising:
a first lens group having a negative refractive power, a second lens group having a positive refractive power and a third lens group having a positive refractive power, the first, second, and third lens groups being arranged in this order from an object side; and
wherein, when a lens position state changes from a maximum wide angle state to a maximum telephoto state, all of the lens groups are moved in an optical axis direction and at least the second lens group moves to the object side and the third lens group moves to an image side so that a distance between the first lens group and the second lens group decreases and a distance between the second lens group and the third lens group increases,
when a subject position changes, the third lens group is moved to perform close-distance focusing,
the first lens group is composed of a negative lens component whose concave surface is directed to the image side and image side lens surface is aspheric, and a positive lens component of meniscus shape whose concave surface is directed to the image side, the positive lens component being arranged on the image side of the negative lens component with air space therebetween,
the second lens group is composed of a positive lens component, and a cemented lens composed of a positive lens of biconvex shape and a negative lens of biconcave shape, the cemented lens being arranged on the image side of the positive lens component with air space therebetween,
the third lens group is composed of a positive lens component in which at least one of an object-side lens surface and an image-side lens surface is aspheric, and
the following conditional expression (1) is satisfied:
0.12<φ24·fw<0.22 (1)
where φ24 is a refractive power of a cemented surface of the cemented lens arranged in the second lens group, and defined by the following equation:
φ24=(n5−n4)/R24 (n5<n4)
where n5 is a refractive index with respect to a d-line (having a wavelength of 587.6 nm) of the negative lens composing the cemented lens arranged in the second lens group; n4 is a refractive index with respect to a d-line of the positive lens composing the cemented lens arranged in the second lens group; R24 is a curvature radius of the cemented surface of the cemented lens arranged in the second lens group; and fw is a focal length of the entire lens system in the maximum wide angle state.

2. The zoom lens according to claim 1, wherein the following expression (2) is satisfied:
0.25<fw/r22<0.32 (2)
where r22 is a curvature radius of the image-side lens surface of the positive lens component arranged in the first lens group.

3. The zoom lens according to claim 1, wherein the following expression (3) is satisfied:
0.5<(r31+r32)/(r31r32)<0.3 (3)
where r31 is a curvature radius of the object-side lens surface of the positive lens component arranged in the second lens group; and r32 is a curvature radius of the image-side lens surface of the positive lens component arranged in the second lens group.

4. The zoom lens according to claim 1, wherein the following expression (4) is satisfied:
1.3<β2w·β2t<1.5 (4)
where β2w is a transverse magnification of the second lens group in the maximum wide angle state; and β2t is a transverse magnification of the second lens group in the maximum telephoto state

5. The zoom lens according to claim 1, wherein the following expression (5) is satisfied:
1.8<f3/fw<3 (5)
where f3 is a focal length of the third lens group.

6. An image pickup apparatus comprising:
a zoom lens; and
a solid image pickup element for converting an optical image formed by the zoom lens into an electrical signal, wherein
the loom lens including:
a first lens group having a negative refractive power, a second lens group having a positive refractive power and a third lens group having a positive refractive power, the first, second, and third lens groups being arranged in this order from an object side; and
wherein, when a lens position state changes from a maximum wide angle state to a maximum telephoto state, all of the lens groups in an optical axis direction are moved in an optical axis direction and at least the second lens group moves to the object side and the third lens group moves to an image side so that a distance between the first lens group and the second lens group decreases and a distance between the second lens group and the third lens group increases,
when a subject position changes, the third lens group moves to perform close-distance focusing,
the first lens group is composed of a negative lens component whose concave surface is directed to the image side and image side lens surface is aspheric, and a positive lens component of meniscus shape whose concave surface is directed to the image side, the positive lens component being arranged on the image side of the negative lens component with air space therebetween,
the second lens group is composed of a positive lens component, and a cemented lens composed of a positive lens of biconvex shape and a negative lens of biconcave shape, the cemented lens being arranged on the image side of the positive lens component with air space therebetween,
the third lens group is composed of a positive lens component in which at least one of an object-side lens surface and an image-side lens surface is aspheric, and
the following conditional expression (1) is satisfied:
0.12<φ24·fw<0.22 (1)
where φ24 is a refractive power of a cemented surface of the cemented lens arranged in the second lens group, and defined by the following equation:
φ24=(n5−n4)/R24 (n5<n4)
where n5 is a refractive index with respect to a d-line (having a wavelength of 587.6 nm) of the negative lens composing the cemented lens arranged in the second lens group; n4 is a refractive index with respect to a d-line of the positive lens composing the cemented lens arranged in the second lens group; R24 is a curvature radius of the cemented surface of the cemented lens arranged in the second lens group; and fw is a focal length of the entire lens system in the maximum wide angle state.
